(19) United States
(12) Patent Application Publication
(10) Pub. No.: US 2022/0032673 A1
(43) Pub. Date: Feb. 3, 2022

(54) THERMAL TRANSFER SHEET

(71) Applicant: Dai Nippon Printing Co., Ltd., Tokyo (JP)

(72) Inventor: Hiroto MATSUI, Tokyo (JP)

(73) Assignee: Dai Nippon Printing Co., Ltd., Tokyo (JP)

(21) Appl. No.: 17/275,711

(22) PCT Filed: Sep. 26, 2019
(86) PCT No.: PCT/JP2019/037832

§ 371 Date: Mar. 12, 2021

(30) Foreign Application Priority Data
Sep. 28, 2018 (JP) 2018-185363
Apr. 4, 2019 (JP) 2019-072338

(51) Int. Cl. B41M 5/41; B41M 5/382; G01N 19/06

(52) U.S. Cl. CPC B41M 5/41; B32B 27/283; G01N 19/06; B41M 5/38214

(57) ABSTRACT

A thermal transfer sheet includes a back face layer provided on one surface of a substrate, and a transfer layer provided on the other surface of the substrate. The transfer layer has a single-layer structure or a layered structure including a protective layer, and the back face layer contains a resin component including Si in the structure. When the thermal transfer sheet is subjected to the test described in the specification, the mass reduction ratio of the thermal transfer sheet between before and after the test is 1% or less.

### TECHNICAL FIELD

The present invention relates to a thermal transfer sheet.

### BACKGROUND ART

Formation of a thermal transferred image on a transfer receiving article using a sublimation-type thermal transfer method has been widely performed because of excellent transparency, high reproducibility and gradation of neutral tints, and easy formability of a high quality image equivalent to conventional full color photographic images. As a print in which a thermal transferred image is formed on a transfer receiving article, there are known digital photographs, and ID cards such as identity cards, driver's licenses, and membership cards, which are used in many fields. Formation of a thermal transferred image according to a sublimation-type thermal transfer method is performed by combining a thermal transfer sheet which is provided with a colorant layer formed on one surface of a substrate with a transfer receiving article, for example, a thermal transfer image-receiving sheet which is provided with a receiving layer formed on one surface of another substrate and applying energy to the back side of the thermal transfer sheet with a heating device such as a thermal head to thereby cause a colorant contained in the colorant layer to migrate onto the transfer receiving article.

By the way, in a thermal transferred image to be formed by the above sublimation-type thermal transfer method, the colorant is not a pigment but a dye having a relatively low molecular weight. Thus, the durability of the thermal transferred image itself is low. Then, usually, with respect to a thermal transferred image formed by the sublimation-type thermal transfer method, a thermal transfer sheet including a protective layer is used to transfer the protective sheet onto the thermal transferred image (see Patent Literatures 1 and 2).

By the way, when a thermal transfer printer including a heating device such as a thermal head and a thermal transfer sheet in which a protective layer as described above is provided are used to transfer the protective layer onto a transfer receiving article with the substrate kept in contact with the thermal head, frictional force occurring between the substrate and the thermal head results in wrinkles on the protective layer. The wrinkles may cause a problem of so-called print omission, in which a portion of the transfer layer originally to be transferred onto the side of the transfer receiving article is not transferred onto the side of the transfer receiving article. Under such a situation, in the field of thermal transfer sheets, a back face layer intended for reducing the frictional force is provided on a surface of the substrate located on the side of the thermal head. Various investigations on an improvement of the lubricity of a back face layer have been made. For example, Patent Literature 3 suggests a thermal transfer sheet including a protective layer and a back face layer containing an organic filler.

However, when the back face layer is caused to contain particles such as a filler in order to reduce the frictional force, the content of the resin component based on the total mass of the back face layer decreases, and the strength of the back face layer tends to decrease. The strength of the back face layer may decrease also depending on the type of the resin component contained in the back face layer. Here, when the strength of the back face layer is low, the back face layer is more likely to be pushed into the side of the transfer layer by the print pressure from the thermal head on transferring the transfer layer, and the surface of the transfer layer transferred will have low smoothness. The smoothness of the surface of the transfer layer is related with the gloss of the transfer layer. When the smoothness of the surface of the transfer layer is low, the gloss of the transfer layer also will be low.

### CITATION LIST

### Patent Literature

Patent Literature 1: Japanese Patent Laid-Open No. 2005-262690
Patent Literature 2: Japanese Patent Laid-Open No. 2002-240404
Patent Literature 3: Japanese Patent Laid-Open No. 2007-307764

### SUMMARY OF INVENTION

### Technical Problem

The present invention has been made in view of the above-mentioned circumstances, and the present invention aims principally to provide a thermal transfer sheet capable of preventing print omission from occurring on a transfer layer to be transferred and producing of a print having a good gloss.

### Solution to Problem

A thermal transfer sheet according to an embodiment of the present disclosure for solving the above problems is a thermal transfer sheet comprising a back face layer provided on one surface of a substrate and a transfer layer provided on the other surface of the substrate, wherein the transfer layer has a single-layer structure or a layered structure comprising a protective layer, the back face layer contains a resin component including Si in the structure, and when the thermal transfer sheet is cut out to a size of 30 mm×230 mm, both the ends in 5 mm of the width in 230 mm of the cut-out thermal transfer sheet are fixed on a fixing table, and a rubbing test is conducted, in which test, a white cotton cloth for friction impregnated with methyl ethyl ketone, with a load of 1.96 N applied thereon, is reciprocated 100 times at a rate of 30 reciprocations per minute on the 30 mm×220 mm area of the back face layer of the fixed thermal transfer sheet in the 220 mm width direction, the mass reduction ratio represented by the following equation is 1% or less.

Mass reduction ratio (%)=((mass of thermal transfer sheet before rubbing test−mass of thermal transfer sheet after rubbing test)/mass of thermal transfer sheet before rubbing test))×100 Equation (1)

In the above thermal transfer sheet, when the element weight ratio of the back face layer surface is measured using an energy dispersive fluorescent X-ray analyzer under the following element weight ratio measurement conditions A, the weight ratio of Si with respect to the weight ratio of C may be 15% or more.

(Element Weight Ratio Measurement Conditions A)
Acceleration voltage: 5 kV
Measurement time: 3 minutes
Measurement magnification: 1000 times

The back face layer may contain a metal soap containing Zn, and when the element weight ratio of the back face layer surface is measured using the energy dispersive fluorescent X-ray analyzer under the following element weight ratio measurement conditions B, the weight ratio of Zn with respect to the weight ratio of C may be 4% or more.

(Element Weight Ratio Measurement Conditions B)
Acceleration voltage: 10 kV
Measurement time: 3 minutes
Measurement magnification: 100 times

The thermal transfer sheet according to an embodiment of the present disclosure for solving the above problems is a thermal transfer sheet comprising a back face layer provided on one surface of a substrate and a transfer layer provided on the other surface of the substrate, wherein the back face layer contains a resin having an alkoxylsilyl group.

One or two or more layers may be provided between the substrate and the back face layer, and the one layer or the two or more layers may contain a resin having an alkoxylsilyl group. Alternatively, a primer layer may be provided between the substrate and the back face layer, and the primer layer may contain a resin having an alkoxylsilyl group. The resin having an alkoxylsilyl group may be an alkoxylsilyl group-modified acrylic resin.

The back face layer may contain a metal soap containing Zn. The metal soap containing Zn may be zinc stearate or zinc stearyl phosphate.

The back face layer may contain a silicone oil. The back face layer may contain a silicone filler.

### Advantageous Effects of Invention

According to the thermal transfer sheet of the present disclosure, it is possible to prevent print omission from occurring on a transfer layer to be transferred and produce a print having a good gloss.

### BRIEF DESCRIPTION OF DRAWINGS

FIG. 1 is a schematic cross-sectional view showing an exemplary thermal transfer sheet of the present disclosure.

FIG. 2 is a schematic cross-sectional view showing an exemplary thermal transfer sheet of the present disclosure.

FIG. 3 is a schematic cross-sectional view showing an exemplary thermal transfer sheet of the present disclosure.

FIG. 4 is a schematic cross-sectional view showing an exemplary thermal transfer sheet of the present disclosure.

### DESCRIPTION OF EMBODIMENTS

### <<Thermal Transfer Sheet>>

Hereinbelow, a thermal transfer sheet 100 according to an embodiment of the present disclosure (hereinbelow, referred to as the thermal transfer sheet of the present disclosure) will be described specifically using the drawings.

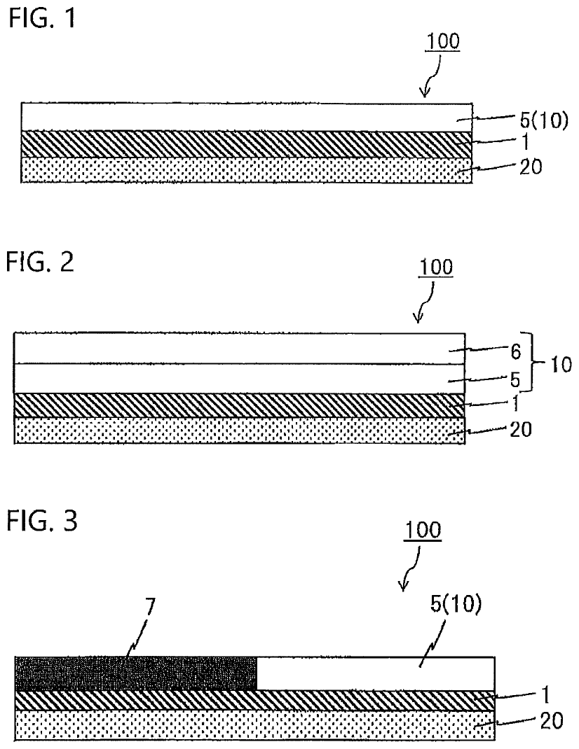

As shown in FIGS. 1 to 3, the thermal transfer sheet 100 of the present disclosure includes a substrate 1, a back face layer 20 provided on one surface of the substrate 1, and a transfer layer 10 provided on the other surface of the substrate 1. The transfer layer 10 has a single-layer or layered structure including a protective layer 5 and can be released from the side of the substrate 1 by application of energy. FIGS. 1 to 3 are schematic cross-sectional views each showing an example of the thermal transfer sheet 100 of the present disclosure.

### (Back Face Layer of First Embodiment)

The back face layer 20 of the first embodiment satisfies the following conditions 1 and 2.

(Condition 1): the back face layer 20 contains a resin component containing Si (the resin may be referred to as a binder resin) in the structure.

(Condition 2): when the thermal transfer sheet is cut out to a size of 30 mm×230 mm, both the ends in 5 mm of the width in 230 mm of the cut-out thermal transfer sheet are fixed on a fixing table, and a rubbing test is conducted, in which test, a white cotton cloth for friction impregnated with methyl ethyl ketone, with a load of 1.96 N applied thereon, is reciprocated 100 times at a rate of 30 reciprocations per minute on the 30 mm×220 mm area of the back face layer in the 220 mm width direction, the mass reduction ratio represented by the following equation is 1% or less.

Mass reduction ratio (%)=((mass of thermal transfer sheet before test−mass of thermal transfer sheet after test)/mass of thermal transfer sheet before test))×100 Equation (1)

According to the thermal transfer sheet 100 of the present disclosure comprising the back face layer 20 of the first embodiment, when the transfer layer 10 is transferred on a transfer receiving article, it is possible to prevent print omission from occurring on the transfer layer 10. It is also possible to make the gloss of the transfer layer 10 transferred on a transfer receiving article good.

In describing advantages of the thermal transfer sheet 100 of the present disclosure comprising the back face layer 20 of the first embodiment, (A) print omission on the transfer layer and (B) gloss of the transfer layer will be described.

### (A) Print Omission on Transfer Layer

The transfer layer is transferred onto a transfer receiving article by bringing the back face layer of the thermal transfer sheet into contact with a heating device (e.g., a thermal head) and moving the heating device on which energy is applied so as to be rubbed on the back face layer. In this time, a predetermined print pressure is applied to the back face layer by the heating device. In the case of transferring the transfer layer in this manner, if the lubricity of the back face layer is low, in other words, if the frictional force between the back face layer and the heating device is high, wrinkles are likely to occur on the back face layer in transferring the transfer layer, and print omission is more likely to occur on the transfer layer to be transferred, due to the wrinkles of the back face layer. The print omission referred to herein means a phenomenon in which, when the transfer layer is transferred on a transfer receiving article, a portion of the transfer layer originally to be transferred onto the transfer receiving article is not transferred onto the transfer receiving article.

Accordingly, in order to prevent print omission on the transfer layer from occurring, it can be said that imparting sufficient lubricity to the back face layer, in other words, reducing the frictional force between the back face layer and the heating device is important. In the thermal transfer sheet 100 of the present disclosure in which this respect is considered, the back face layer 20 satisfies the above condition 1. According to the thermal transfer sheet of the present disclosure comprising the back face layer 20 satisfying the above condition 1, the presence of the resin component containing Si in the structure enables the lubricity of the back face layer 20 to be good. Thereby, in transferring the transfer layer 10, it is possible to prevent wrinkles from occurring on the back face layer 20 and prevent print omission from occurring on the transfer layer 10 to be transferred. Further, also in image formation using a colorant layer mentioned below, it is possible to prevent print omission from occurring on the thermal transferred image.

### (B) Gloss of Transfer Layer

The gloss of the transfer layer transferred on the transfer receiving article is related with the smoothness of the surface of the transfer layer. The higher the smoothness of the transfer layer of the transfer receiving article, the higher the gloss of the transfer layer transferred. As described above, in transferring the transfer layer onto the transfer receiving article, a predetermined print pressure is applied on the back face layer by a heating device. The smoothness of the surface of the transfer layer to be transferred varies in accordance with the conformability of the back face layer to the pushing-in by the heating device when a print pressure is applied by the heating device. When a back face layer having high conformability to the pushing-in by the heating device is used, the back face layer is easily pushed into the side of the transfer layer by the print pressure of the heating device. Since the back face layer is pushed into the side of the transfer layer, the transfer layer follows the pushing-in to be also pushed in. Thus, the smoothness of the surface of the transfer layer transferred will be low. That is, when a back face layer having high conformability to the pushing-in of the heating device is used, the gloss of the transfer layer transferred will be lower. When the back face layer contains various additives and has high conformability to the pushing-in of the back face layer, irregularities are also caused on the surface of the transfer layer by the additives pushed in, and the smoothness of the surface of the transfer layer becomes lower. That is, in order to increase the gloss of the transfer layer transferred, it can be said that the low conformability of the back face layer to the print pressure (pushing-in) by the heating device is important. Examples of a device to lower the conformability of the back face layer to the print pressure include devices to enhance the strength of the back face layer.

The back face layer of the first embodiment further satisfies the above condition 2. According to the thermal transfer sheet 100 of the present disclosure comprising the back face layer 20 of the first embodiment, it is possible to enhance the strength of the back face layer 20 while sufficient lubricity is imparted to the back face layer 20. Thereby, it is possible to prevent print omission from occurring on the transfer layer 10 to be transferred on the transfer receiving article and further, it is possible to make the gloss of the transfer layer 10 to be transferred on the transfer receiving article good. When the above condition 2 is not satisfied, specifically when the mass reduction ratio of the thermal transfer sheet between before and after the test exceeds 1%, it is not possible to impart sufficient strength to the back face layer of the first embodiment, and it is not possible to make the gloss of the transfer layer transferred on the transfer receiving article sufficient. When the above condition 1 is not satisfied, it is difficult to satisfy the above condition 2.

The above condition 2 is an index indicating the strength of the back face layer 20 of the first embodiment. When the condition 2 is satisfied, in other words, when the mass reduction ratio of the thermal transfer sheet 100 after the test under the above condition 2 is 1% or less, it is indicated that the strength of the back face layer 20 is high enough to enable the gloss of the transfer layer 10 to be transferred to be good. The mass reduction ratio of the thermal transfer sheet 100 of a preferred aspect is 0.5% or less.

The above condition 2, which is a method based on JIS-L-0849 (2013), uses methyl ethyl ketone, rather than water, as a solvent with which a white cotton cloth is impregnated. The load and measurement range are as described in the above condition 2. As an abrasion tester type II (Gakushin-Type), an abrasion tester (abrasion tester FR-II, Suga Test Instruments Co., Ltd.) is used. Methyl ethyl ketone is used in the test because it has been found that the mass reduction ratio (%) of the thermal transfer sheet in the measurement under the above condition 2 is related with the strength of the back face layer.

Hereinbelow, the specific structure of the back face layer 20 of the first embodiment that may satisfy the above conditions 1 and 2 will be described with reference to one example. The thermal transfer sheet 100 of the present disclosure comprising the back face layer 20 of the first embodiment is not limited to the following embodiment.

### (One Example of Embodiment of Back Face Layer)

The back face layer 20 of the first embodiment contains a resin component containing Si therein in order to satisfy the above condition 1. Hereinbelow, the resin component containing Si therein is referred to as the Si-containing resin. As the Si-containing resin, it is only required to appropriately select one that can satisfy the above condition 2.

There is no limitation on the Si-containing resin, and it is only required to use one that can satisfy at least the above condition 2. Examples of the Si-containing resin can include resins having an alkoxylsilyl group (including alkoxylsilyl group-modified resins, which include an alkoxylsilyl group introduced), polysiloxane, and silicone-modified forms of various resins. Examples of the alkoxylsilyl group can include a trialkoxylsilyl group, a dimethoxysilyl group, and a monoalkoxylsilyl group. Examples of the resin having an alkoxylsilyl group can include alkoxylsilyl group-modified acrylic resins, alkoxylsilyl group-modified polyesters, alkoxylsilyl group-modified epoxy resins, alkoxylsilyl group-modified alkyd resins, alkoxylsilyl group-modified fluorine resins, alkoxylsilyl group-modified polyurethane, alkoxylsilyl group-modified phenol resins, and alkoxylsilyl group-modified melamine resins. The component constituting the above resin having an alkoxylsilyl group, polysiloxane, and silicone-modified products of various resins may be any of polymers, prepolymers, oligomers, and monomers. Among these, an alkoxylsilyl group-modified acrylic resin, in which an alkoxylsilyl group is introduced at a side chain or end of the acrylic resin skeleton, is a preferred Si-containing resin in respect of easily satisfying the above condition 2 and being capable of imparting higher strength to the back face layer 20.

The resin having an alkoxylsilyl group may be one obtained by curing with various curing agents. In other words, the resin may be a reaction product of a resin having an alkoxylsilyl group and a curing agent (including a crosslinking agent). The resin having an alkoxylsilyl group referred to herein is intended to include reaction products of a resin having an alkoxylsilyl group and a curing agent. Examples of the reaction product of a resin having an alkoxylsilyl group and a curing agent can include siloxane crosslinked resins (Si-containing resins) including a “Si—O—Si” crosslinked structure formed by hydrolysis of an alkoxylsilyl group of a resin having an alkoxylsilyl group and a silanol reaction.

There is no limitation on the content of the Si-containing resin based on the total mass of the back face layer 20 of the first embodiment. The content is preferably 45% by mass or more, more preferably 65% by mass or more.

The back face layer 20 of the first embodiment may also contain a curing agent for curing a Si-containing resin. In other words, the back face layer 20 may contain a Si-containing resin cured by a curing agent. Examples of the curing agent in the case where an alkoxylsilyl group-modified acrylic resin is used as the Si-containing resin can include a zirconia-type curing agent, an aluminum-type curing agent, a titanium-type curing agent, and a tin-type curing agent. There is no limitation on the content of the curing agent, and an example of the content of the curing agent is 0.01% by mass or more and 20% by mass or less based on the total mass of a composition to obtain the back face layer 20 of the first embodiment.

The back face layer 20 of the first embodiment may contain a resin component other than the Si-containing resin as long as the above conditions 1 and 2 are satisfied. Examples of the other resin component can include polyesters, polyacrylic esters, polyvinyl acetate, acryl-styrene copolymers, polyurethane, polyolefins such as polyethylene and polypropylene, polystyrene, polyvinyl chloride, polyethers, polyamides, polyimides, polyamideimides, polycarbonate, polyacrylamide, polyvinyl chloride, and polyvinyl acetals such as polyvinyl acetoacetal and polyvinyl butyral.

The back face layer 20 of the first embodiment may also contain various additives, in addition to the above resin component and the above curing agent to be used as required. A preferred back face layer 20 of the first embodiment contains a lubricant for the purpose of improving the lubricity of the back face layer 20 and a filler as additives. Examples of the lubricant can include silicone oils, polyethylene wax, paraffin wax, higher fatty acid esters, higher fatty acid amides, higher aliphatic alcohols, organopolysiloxane, anionic surfactants, cationic surfactants, amphoteric surfactants, nonionic surfactants, fluorine type surfactants, organic carboxylic acids and derivatives thereof, and metal soaps. Examples of the filler can include organic fillers such as silicone fillers (the silicone fillers may be referred to as silicone resin particles), fluorine fillers, acryl fillers, nylon fillers, PTFE (polytetrafluoroethylene) fillers, butadiene rubber fillers, melamine fillers, styrene fillers, and nylon fillers, and inorganic fillers such as talc. Additives other than these also may be used.

The preferred back face layer 20 of the first embodiment satisfies the following condition 3 in addition to the above conditions 1 and 2.

(Condition 3): when the element weight ratio of the surface of the back face layer 20 is measured using an energy dispersive fluorescent X-ray analyzer under the following element weight ratio measurement conditions A, the weight ratio of Si with respect to the weight ratio of C is 15% or more.

(Element Weight Ratio Measurement Conditions A)
Acceleration voltage: 5 kV
Measurement time: 3 minutes
Measurement magnification: 1000 times

According to the back face layer 20 of the first embodiment further satisfying the condition 3, it is possible to make the lubricity of the back face layer 20 better. When only the above condition 1 is satisfied and the above condition 3 may not be satisfied, a Si-type additive or the like may be used in combination.

As the energy dispersive fluorescent X-ray analyzer, a combination of a scanning electron microscope (SU1510, Hitachi High-Technologies Corporation) and an energy dispersive X-ray spectrometer (EDAX OCTANE PRIME, AMETEK, Inc.) was used. In accordance with the above weight ratio measurement conditions, the weight ratio of C and the weight ratio of Si each can be measured based on the total mass of the elements to be measured. For example, the elements to be measured in measurement of the surface of the back face layer are C, F, and Si. When the weight ratio of C is 0.6 (60%), the weight ratio of F is 0.2 (20%), and the weight ratio of Si is 0.2 (20%) based on the total mass of these elements, the weight ratio of Si with respect to the weight ratio of C will be (the weight ratio of Si 0.2 (20%)/the weight ratio of C 0.6 (60%))≈0.33 (33%). The same applies to the weight ratio of Zn with respect to the weight ratio of C below. Examples of the elements that can be measured under the above element weight ratio measurement conditions A can include B, C, N, O, F, Na, Mg, Al, Si, P, S, and Cl.

There is no limitation on the measurement region of the back face layer 20 in the above condition 3, and it is only required to measure a portion of the back face layer overlapping with the transfer layer 10. An exemplary measurement region is the portion of the back face layer 20 overlapping with the center portion of the transfer layer 10. In advance of measurement for the above condition 3, the back face layer is subjected to sputtering (target: Pt (platinum)) to form a Pt (platinum) thin film having a thickness of 10 nm or less.

The preferred back face layer 20 of the first embodiment also contains a Si-type lubricant and a Si-type filler. Specifically, the back layer 20 contains a silicone oil or a silicone filler. The back face layer 20 further preferably contains a silicone oil and a silicone filler. According to the back face layer 20 of the first embodiment satisfying the above conditions 1 and 2, more preferably satisfying the above conditions 1 to 3, and containing either one of a Si-type lubricant and a Si-type filler or both, it is possible to more effectively prevent print omission on the transfer layer to be transferred and also make the gloss of the transfer layer 10 to be transferred better. The shape of the silicone filler is preferably true spherical. The particle size of the silicone filler is preferably 0.5 μm or more and 3 μm or less.

When the weight ratio of Si in the above condition 3 is supposed to be constant, a back face layer 20 containing a Si-type lubricant or a Si-type filler in addition to the Si-containing resin can make the effect of preventing print omission and the gloss of the transfer layer better than a back face layer 20 containing the Si-containing resin with a non Si-type lubricant or filler can. Even when the back face layer 20 of the first embodiment contains no Si-type lubricant or filler, satisfying the above conditions 1 and 2 enables the print omission to be prevented and the gloss of the transfer layer to be enhanced.

A particularly preferred back face layer 20 of the first embodiment contains either one of a silicone oil and a silicone filler and satisfies the above condition 3. Further, the weight ratio of Si in the above condition 3 is 45% or more. In this aspect, the total content of the silicone oil and the silicone filler is preferably 4% by mass or more and 50% by mass or less, more preferably more than 5% by mass and 40% by mass or less based on the total mass of the back face layer 20 of the first embodiment.

A most preferred back face layer 20 of the first embodiment contains a silicone oil and a silicone filler and satisfies the above condition 3. Further, the weight ratio of Si in the above condition 3 is 45% or more. In this aspect, the each content of the silicone oil and the silicone filler is preferably 2% by mass or more and 25% by mass or less, more preferably 2.5% by mass or more and 40% by mass or less based on the total mass of the back face layer 20 of the first embodiment. In the case where the back face layer 20 contains a metal soap containing Zn described below or where an intermediate layer or a back face primer layer 25 of a preferred aspect described below is provided between the substrate 1 and the back face layer 20, it is possible to improve the effect of preventing print omission and the gloss of the transfer layer without allowing a silicone oil or a silicone filler to be contained.

The preferred back face layer 20 of the first embodiment contains a metal soap containing Zn. A further preferred back face layer 20 of the first embodiment contains a metal soap containing Zn, and when the element weight ratio of the back face layer surface is measured using an energy dispersive fluorescent X-ray analyzer under the following element weight ratio measurement conditions B, the weight ratio of Zn with respect to the weight ratio of C is 4% or more, more preferably 4.5% or more, further preferably 5% or more. Particularly preferably, the weight ratio of Zn is in the preferred range described above, and either one of a silicone oil and a silicone filler or both are contained. Alternatively, the weight ratio of Zn is in the preferred range described above, and the intermediate layer or the back face primer layer is an intermediate layer or a back face primer layer of a preferred aspect described below.

(Element Weight Ratio Measurement Conditions B)
Acceleration voltage: 10 kV
Measurement time: 3 minutes
Measurement magnification: 100 times

According to the back face layer 20 of this aspect, presence of the metal soap containing Zn can prevent the component contained in the back face layer 20 from moving to another constituent member when the back face layer 20 comes in contact with the another constituent member. The back face layer 20 of the aspect is suitable when the back face layer 20 contains an oil component such as a silicone oil. For example, in the case where the back face layer 20 of the first embodiment is configured to include an oil component such as an silicone oil and a metal soap containing Zn, if this back face layer is formed on one surface of the substrate 1 and this is wound for temporary storage, it is possible to prevent the oil component contained in the back face layer 20 from moving to the other surface of the substrate. Thereby, thereafter, when the transfer layer 10 is formed on the other surface of the substrate 1, it is possible to make the adhesion between the substrate and the transfer layer good and prevent unevenness from occurring in the transfer layer to be formed on the other surface of the substrate. Besides these, also when the thermal transfer sheet is configured to have a colorant 7 and a transfer layer 10 provided in a frame-sequential manner on one surface of a substrate 1 as shown in FIG. 3 and this thermal transfer sheet is wound up, it is also possible to prevent the oil component contained in a back face layer 20 from moving to the colorant layer 7 in contact with the back face layer 20.

When the back face layer 20 contains a metal soap containing Zn and contains no silicone oil or silicone filler or when the back face layer 20 contains a metal soap containing Zn and the sum mass of either one of a silicone oil and a silicone filler or both is 5% by mass or less with respect to the total mass of the back face layer 20, the weight ratio of Zn with respect to the weight ratio of C is preferably 6% or more, more preferably 7% or more. According to the back face layer 20 of this aspect, it is possible to make prevention of print omission more sufficient.

The element weight ratio measurement conditions B are common to the above element weight ratio measurement conditions A except that the acceleration voltage is changed from 5 kV to 10 kV and the measurement magnification is changed from 1000 times to 100 times.

According to the back face layer 20 of this aspect, it is possible to make the lubricity of the back face layer 20 further good.

There is no limitation on the content of the metal soap containing Zn. The content is preferably adjusted such that the weight ratio of Zn with respect to the weight ratio of C will be the above preferred weight ratio.

There is no particular limitation on a method for forming the back face layer 20 of the first embodiment. The back face layer may be formed by dispersing or dissolving a Si-containing resin and additives such as a curing agent and a lubricant to be used as required in an appropriate solvent to prepare a coating liquid for back face layer, applying this coating liquid on one surface of the substrate 1 or an optional layer provided on the one surface of the substrate 1 (e.g., a back face primer layer 25 mentioned below), and drying the applied liquid such that a back face layer satisfying the above conditions 1 and 2 is provided. Examples of the coating method can include a gravure printing method, a screen printing method, and a reverse roll coating method using a gravure printing plate. Coating methods other than these methods also may be used. The same applies to coating methods for various coating liquids mentioned below.

### (Back Face Layer of Second Embodiment)

The back face layer 20 of the second embodiment contains a resin having an alkoxylsilyl group. According to the thermal transfer sheet 100 according to the embodiment of the present disclosure comprising the back face layer 20 of the second embodiment, it is possible to make the strength and lubricity good, in comparison with a back face layer 20 containing no resin having an alkoxylsilyl group.

The above back face layer 20 of the first embodiment is conditioned to satisfy the above conditions 1 and 2, whereas the back face layer 20 of the second embodiment is conditioned to contain a resin having an alkoxylsilyl group. In this respect, the back face layer 20 of the second embodiment is different from the above back face layer 20 of the first embodiment. Accordingly, it is not necessary for the back face layer 20 of the second embodiment to satisfy the above conditions 1 and 2. Except for this difference, it is possible to appropriately select and use the constituents described for the above back face layer 20 of the first embodiment. Accordingly, the phrase “the above back face layer 20 of the first embodiment” is only required to be replaced by “the back face layer 20 of the second embodiment”. Additionally, in the back face layer 20 of the second embodiment, the phrase “to satisfy the above conditions 1 and 2” in the back face layer 20 of the first embodiment is only required to be replaced by “to contain a resin having an alkoxylsilyl group”. The preferred aspects described in the back face layer 20 of the first embodiment can be applied as they are to the back face layer 20 of the second embodiment.

As the resin having an alkoxylsilyl group contained in the back face layer 20 of the second embodiment, those described for the above back face layer 20 of the first embodiment can be appropriately selected and used. Among resins having an alkoxylsilyl group, an alkoxylsilyl group-modified acrylic resin, in which an alkoxylsilyl group is introduced at a side chain or end of the acrylic resin skeleton, is preferred in that the resin can make the strength and lubricity of the back face layer 20 higher than other resins having an alkoxylsilyl group can.

In the present embodiment, there is no limitation on the content of the resin having an alkoxylsilyl group based on the total mass of the back face layer 20. In accordance with the content of the resin having an alkoxylsilyl group, it is possible to make the strength and lubricity good. The back face layer 20 of a preferred aspect contains 45% by mass or more, more preferably, 65% by mass or more of the resin having an alkoxylsilyl group based on the total mass of the back face layer 20.

The back face layer 20 of the second embodiment also preferably contains a metal soap containing Zn. According to the back face layer 20 of this aspect, it is possible to make the lubricity of the back face layer 20 better. Examples of the metal soap containing Zn can include zinc stearate, zinc stearyl phosphate, zinc laurate, zinc ricinolate, and zinc octylate. Among these, zinc stearate and zinc stearyl phosphate are preferred in respect of enabling the lubricity of the back face layer 20 better in comparison with metal soaps containing Zn other than these.

The content of the metal soap containing Zn is preferably 4% by mass or more and 45% by mass or less, more preferably 6% by mass or more and 45% by mass or less based on the total mass of the back face layer 20.

The back face layer 20 of the second embodiment preferably contains a Si-type lubricant and a Si-type filler, similarly to the above back face layer 20 of the first embodiment.

There is no particular limitation on a method for forming the back face layer 20 of the second embodiment. The back face layer may be formed by dispersing or dissolving a resin having an alkoxylsilyl group, additives such as a curing agent and a lubricant to be used as required in an appropriate solvent to prepare a coating liquid for back face layer, applying this coating liquid on one surface of the substrate 1 or an optional layer provided on the one surface of the substrate 1 (e.g., a back face primer layer mentioned below), and drying the applied liquid.

Hereinbelow, constituents other than the back face layer of the thermal transfer sheet 100 of the present disclosure will be described with reference to one example. The back face layer 20 referred to hereinbelow includes both the back face layers of the above first embodiment and second embodiment.

There is no limitation on the thickness of the back face layers 20 of the first embodiment and second embodiment. The thickness is preferably 0.1 μm or more and 2 μm or less, more preferably 0.2 μm or more and 1 μm or less. Allowing the back face layer 20 to have a preferred thickness enables print omission on the transfer layer to be more sufficiently prevented and the gloss of the transfer layer to be better. It is also possible to make the transfer sensitivity of the transfer layer good.

### (Back Face Primer Layer)

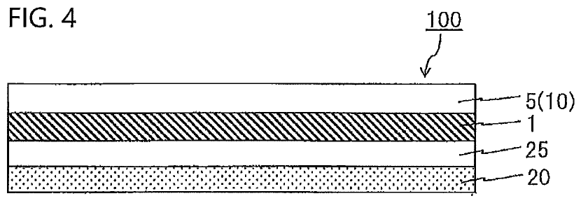

As shown in FIG. 4, a back face primer layer 25 may be provided between the substrate 1 and the back face layer 20. The back face primer layer 25 is a layer to be provided in order to improve the adhesion between the substrate 1 and the back face layer 20, being an optional constituent in the thermal transfer sheet 100 of the present disclosure. FIG. 4 is a schematic cross-sectional view showing an exemplary thermal transfer sheet of the present disclosure. Although the transfer layer 10 having a single-layer structure is provided on the substrate 1 in FIG. 4, a transfer layer 10 having a layered structure may be acceptable.

Examples of the resin component constituting the back face primer layer 25 can include polyesters, polyurethane, acrylic resins, polycarbonate, polyamides, polyimides, polyamideimides, vinyl chloride-vinyl acetate copolymers, polyvinyl acetals such as polyvinyl butyral and polyvinyl acetoacetal, polyvinyl alcohol, and polyvinyl pyrrolidone.

The back face primer layer 25 of a preferred aspect contains a resin having an alkoxylsilyl group, more preferably contains an alkoxylsilyl group-modified acrylic resin. According to the back face primer layer 25 of this aspect, it is possible to impart sufficient heat resistance to the back face primer layer 25, and even in the case of increasing the energy to be applied from the heating device to the back face layer in transferring the transfer layer, it is possible to prevent loosening of the back face primer layer 25 from occurring. Thus, according to the back face primer layer 25 of this aspect, the synergistic effect of the first embodiment described above and the back face layer 20 of the second embodiment can sufficiently prevent print omission on the transfer layer from occurring, even in the case of increasing the energy to be applied from the heating device to the back face layer in transferring the transfer layer.

As the resin having an alkoxylsilyl group, those exemplified above can be appropriately selected and used. For the back face primer layer 25, one resin having an alkoxylsilyl group may be used, or two or more of such resins may be used. The back face primer layer 25 may contain the resin components for the back face primer layer exemplified above along with the resin having an alkoxylsilyl group

The content of the resin having an alkoxylsilyl group is preferably 50% by mass or more, more preferably 60% by mass or more based on the total mass of the back face primer layer 25.

The thickness of the back face primer layer 25 is preferably 0.01 μm or more and 2 μm or less, more preferably 0.02 μm or more or 1 μm or less.

There is no particular limitation on a method for forming the back face primer layer 25. The back face primer layer 25 can be formed by dispersing or dissolving the components exemplified above in an appropriate solvent to prepare a coating liquid for back face primer layer, applying this coating liquid onto the other surface of the substrate 1, and drying the applied liquid.

Instead of or in addition to the aspect in which a resin having an alkoxylsilyl group is contained in the above back face primer layer 25, an intermediate layer (not shown) may be provided between the substrate 1 and the back face layer 20, and a resin having an alkoxylsilyl group may be contained in this intermediate layer. That is, an aspect may be acceptable in which one or two or more layers are positioned between the substrate 1 and the back face layer 20 and a resin having an alkoxylsilyl group is contained in at least one of the layers positioned between the substrate 1 and the back face layer 20. For example, an aspect may be acceptable in which the back face primer layer 25, the intermediate layer, the back face primer layer 25, and the back face layer 20 are positioned in this order from the side of the substrate 1 and a resin having an alkoxylsilyl group is contained in either one or both of the back face primer layers 25 and the intermediate layer positioned between the substrate 1 and the back face layer 20.

### (Substrate)

The substrate 1 is an essential component in the thermal transfer sheet 100 of the present disclosure and supports the above back face layer 20 provided on one surface of the substrate 1, the transfer layer 10 provided on the other surface of the substrate 1, and the like. There is no limitation on the material of the substrate 1, and the material desirably has heat resistance and mechanical characteristics. Examples of the substrate 1 like this can include various plastic films or sheets of polyesters such as polyethylene terephthalate, polycarbonate, polyimides, polyether imides, cellulose derivatives, polyethylene, polypropylene, styrene resins, acrylic resins, polyvinyl chloride, polyvinylidene chloride, nylon, or polyether ether ketone. The thickness of the substrate 1 may be appropriately selected depending on the kind of the material of the substrate, so that the strength, heat resistance and the like of the substrate sheet lie in appropriate ranges, and is generally 2.5 μm or more and 100 μm or less.

### (Transfer Layer)

As shown in FIG. 1 to FIG. 3, the transfer layer 10 is provided on the other surface of the substrate 1 (the upper surface of the substrate in the aspect shown). The transfer layer 10 has a single-layer structure composed only of a protective layer 5 (see FIG. 1 and FIG. 3) or has a layered structure including a protective layer (see FIG. 2). The transfer layer 10 of the aspect shown in FIG. 2 has a layered structure of a protective layer 5 and an adhesive layer 6 which are layered in this order from the side of the substrate 1. The transfer layer 10 is not limited to the aspect shown and is only required to satisfy a condition of inclusion of the protective layer 5. For example, in the aspect shown in FIG. 2, the transfer layer 10 may have a configuration in which a primer layer intended to improve the adhesion between the protective layer 5 and the adhesive layer 6 is provided between the protective layer 5 and the adhesive layer, or may have a configuration in which various functional layers are provided on the protective layer 5. Among layers constituting the transfer layer 10, the layer located nearest from the substrate 1 may be a peelable layer. Alternatively, the constituents shown in each figure may be appropriately combined.

### (Protective Layer)

There is no limitation on the protective layer 5, and protective layers conventionally known in the field of thermal transfer sheets can be appropriately selected and used. Examples of the resin component constituting the protective layer 5 can include polyesters, polystyrene, acrylic resins, polyurethane, acryl urethane, resins obtained by silicone-modifying each of these resins, cured products of an active ray-curable resin, and any blends of these resins. The active ray-curable resin referred to herein means a precursor or a composition before irradiated with an active ray. The active ray-curable resin referred to herein also means a radioactive ray which is allowed to chemically act on an active ray-curable resin to promote polymerization, specifically meaning a visible light ray, an ultraviolet ray, an X ray, an electron beam, an α ray, a β ray, a γ ray, or the like. The protective layer 5 may contain one resin component or may contain two or more resin components. When the transfer layer 10 is caused to have a single-layer structure composed only of a protective layer 5 or when, among layers constituting the transfer layer 10, the protective layer 5 is caused to be located farthest from the substrate 1, an adhesive property may be imparted to the protective layer 5 by causing the protective layer 5 to contain a resin component having an adhesive property mentioned below.

The protective layer 5 may contain other components along with the above resin component. Examples of the other components can include a filler. It is possible to improve the foil cutting property of the transfer layer 10 by causing the protective layer 5 to contain a filler.

Examples of the filler can include organic fillers, inorganic fillers, and organic-inorganic hybrid-type fillers. The filler may be a powder or a sol-type one, but a powder filler is preferably used because of its wide solvent-selectivity when a coating liquid for protective layer is prepared.

The content of the filler is preferably 10% by mass or more and 60% by mass or less, more preferably 10% by mass or more and 50% by mass or less, even more preferably 20% by mass or more and 40% by mass or less, based on the total mass of the protective layer 5.

There is not particular limitation on the thickness of the protective layer 5, and the thickness is preferably 1 μm or more and 15 μm or less, more preferably 2 μm or more and 6 μm or less. Setting the thickness of the protective layer 5 within this range enables the foil cutting property to be improved. Additionally, physical durability and chemical durability imparted to a print obtained by transferring the transfer layer 10 onto a transfer receiving article to be good.

There is no limitation on a method for forming the protective layer 5. The protective layer 5 may be formed by dissolving or dispersing a resin component and various additive to be used as required in an appropriate solvent to prepare a coating liquid for protective layer, applying the coating liquid on one surface of the substrate 1 or an optional layer provided on the one surface of the substrate 1 (e.g., a release layer mentioned below), and drying the coated liquid. A protective layer 5 including a cured product of an active ray-curable resin may be formed by preparing a coating liquid for protective layer including an active ray-curable resin, applying the coating liquid on the other surface of the substrate 1 or an optional layer provided on the other surface of the substrate 1 to form a coated film of a protective layer, and irradiating this coated film with an active ray to crosslink and cure the polymerization components such as the above polymerizable copolymer. When ultraviolet irradiation is applied as active ray irradiation, conventionally known ultraviolet irradiation apparatuses can be used. For example, various apparatuses such as high pressure mercury lamps, low pressure mercury lamps, carbon arcs, xenon arcs, metal halide lamps, non-electrode ultraviolet lamps, and LEDs can be used without limitation. Alternatively, when an electron beam is applied as active ray irradiation, a high energy-type electron beam irradiation apparatus that applies an electronic beam at an energy of 100 keV or more and 300 keV or less, a low energy-type electron beam irradiation apparatus that applies an electronic beam at an energy of 100 keV or less, or the like can be used. In terms of the irradiation mode, either of a scanning-type irradiation apparatus or a curtain-type irradiation apparatus may be used.

There is no particular limitation on the thickness of the protective layer 5, and the thickness is generally 0.5 μm or more and 10 μm or less.

### (Adhesive Layer)

As shown in FIG. 2, the transfer layer 10 may have a layered structure of a protective layer 5 and an adhesive layer 6 which are layered in this order from the side of the substrate 1. According to the transfer layer 10 of this aspect, it is possible to impart better adhesion to the transfer layer 10 without causing the protective layer 5 to contain a component for imparting adhesion to a transfer receiving article (component having adhesion).

There is no particular limitation on the resin component having an adhesive layer, and examples thereof can include resin components, such as polyurethanes, polyolefins such as α-olefin-maleic anhydride, polyesters, acrylic resins, epoxy resins, urea resins, melamine resins, phenol resins, polyvinyl acetate, vinyl chloride-vinyl acetate copolymers, and cyano acrylate.

The thickness of the adhesive layer 6 is preferably 0.5 μm or more and 10 μm or less. There is no limitation on a method for forming the adhesive layer, and the adhesive layer may be formed by dispersing or dissolving the adhesive exemplified above and additives to be added as required in an appropriate solvent to prepare a coating liquid for adhesive layer, applying this coating liquid onto the protective layer 5 or an optional layer provided on the protective layer 5, and drying the applied liquid.

### (Peelable Layer)

When the transfer layer 10 is a transfer layer 10 having a layered structure including the protective layer 5, a peelable layer may be located nearest from the substrate 1 (not shown), among layers constituting the transfer layer 10.

Examples of the resin component of the peelable layer can include ethylene-vinyl acetate copolymers, vinyl chloride-vinyl acetate copolymers, maleic acid-modified vinyl chloride-vinyl acetate copolymers, polyamides, polyesters, polyethylene, ethylene-isobutyl acrylate copolymers, butyral, polyvinyl acetate and copolymers thereof, ionomer resins, acid-modified polyolefins, (meth)acrylic resins, acrylic acid ester resins, ethylene-(meth)acrylic acid copolymers, ethylene-(meth)acrylic acid ester copolymers, polymethyl methacrylate, cellulose resins, polyvinyl ethers, polyurethanes, polycarbonate, polypropylene, epoxy resins, phenol resins, vinyl resins, maleic acid resins, alkyd resins, polyethylene oxides, urea resins, melamine resins, melamine-alkyd resins, silicone resins, rubber-type resins, styrene-butadiene-styrene block copolymers (SBS), styrene-isoprene-styrene block copolymers (SIS), styrene-ethylene-butylene-styrene block copolymers (SEBS), and styrene-ethylene-propylene-styrene block copolymers (SEPS).

There is not particular limitation on the thickness of the peelable layer, and the thickness is preferably 1 μm or more and 15 μm or less.

### (Release Layer)

A release layer (not shown) may be provided between the substrate 1 and the transfer layer 10. Examples of the components of the release layer can include waxes, silicone wax, silicone resins, silicone-modified resins, fluorine resins, fluorine-modified resins, polyvinyl alcohol, acrylic resin, thermally crosslinkable epoxy-amino resins, and thermally crosslinkable alkyd-amino resins.

The thickness of the release layer is generally 0.5 μm or more and 5 μm or less. There is no limitation on a method for forming the release layer, and, for example, the release layer may be formed by dispersing or dissolving the above components in an appropriate solvent to prepare a coating liquid for release layer, applying this coating liquid onto the substrate 1, and drying the applied liquid.

When the release layer is provided on the substrate 1, the surface of the substrate 1 on the side of the release layer may be subjected to adhesive treatment in order to improve the adhesion between the substrate 1 and the release layer. As the adhesive treatment, a known resin surface modification technique, for example, corona discharge treatment, flame treatment, ozone treatment, ultraviolet treatment, radiation treatment, roughening treatment, chemical treatment, plasma treatment, low-temperature treatment, primer treatment, and grafting treatment, can be applied as it is. Two or more of these treatments also can be used in combination.

### (Colorant Layer)

As shown in FIG. 3, a colorant layer 7 may be provided on the other surface of the substrate 1 so as to be frame sequential to the transfer layer 10 described above. In the thermal transfer sheet 100 of the aspect shown in FIG. 3, a single colorant layer 7 is provided on the other surface of the substrate 1 (a portion of the upper face of the substrate 1 in the aspect shown). On the other surface of the substrate, a plurality of colorant layers, for example, a yellow colorant layer, a magenta colorant layer, a cyan colorant layer, a black colorant layer, and the like may be provided in a frame-sequential manner. When the colorant layer 7 and the transfer layer 10 are used to form “one unit”, the “one unit” can be repeatedly provided on the other surface of the substrate 1.

According to the thermal transfer sheet of the aspect shown in FIG. 3, it is possible to form a thermal transferred image on a transfer receiving article and transfer the transfer layer 10 onto the formed thermal transferred image using one thermal transfer sheet 100. Additionally, when a thermal transferred image is formed, it is possible to prevent print omission from occurring on the thermal transferred image by means of the back face layer 20 described above. In other words, according to the thermal transfer sheet of the aspect shown in FIG. 3, it is possible to prevent print omission from occurring on both the thermal transferred image to be formed and the transfer layer to be transferred and make the gloss of the transfer layer to be transferred well.

The thermal transfer sheet according to another embodiment of the present disclosure has a configuration in which the transfer layer 10 including the protective layer 5 described above is replaced by either one or both of a transfer layer having a single-layer or layered structure including a protective layer 7 to be used for the melt-type thermal transfer method and a colorant layer 7 to be used for the sublimation-type thermal transfer method.

The thermal transfer sheet 100 of the present disclosure having the colorant layer 7 may be a thermal transfer sheet 100 to be used for forming a thermal transferred image by a sublimation-type thermal transfer method or may be a thermal transfer sheet 100 to be used for forming a thermal transferred image by a melt-type thermal transfer method. These may be combined to form a thermal transfer sheet 100.

### (Colorant Layer to be Used for Sublimation-Type Thermal Transfer Method)

There is no limitation on a binder resin contained in the colorant layer 7 to be used for the sublimation-type thermal transfer method, and examples thereof can include resin components including cellulosic resins, such as ethyl cellulose, hydroxyethyl cellulose, ethyl hydroxy cellulose, methyl cellulose, and cellulose acetate, vinyl resins such as polyvinyl alcohol, polyvinyl acetate, polyvinyl butyral, polyvinyl acetoacetal, and polyvinyl pyrrolidone, acrylic resins such as poly(meth)acrylate and poly(meth)acrylamide, polyurethanes, polyamides, and polyesters.

There is no particular limitation on the content of the binder resin, and the content of the binder resin is preferably 20% by mass or more based on the total mass of the colorant layer 7. Setting the content of the binder resin to 20% by mass or more based on the total mass of the colorant layer 7 enables a sublimable dye to be sufficiently maintained in the colorant layer 7 to thereby result in an improvement in storage stability. There is no particular limitation on the upper limit of the content of the binder resin, and the upper limit is only required to be determined in accordance with the content of the sublimable dye and optional additives.

The colorant layer 7 to be used for the sublimation-type thermal transfer method contains a sublimable dye as the colorant component. There is no particular limitation on the sublimable dye, and sublimable dyes having a sufficient color density and not discoloring and fading due to light, heat, temperature, and the like are preferred. Examples of the dye can include diarylmethane-type dyes, triarylmethane-type dyes, thiazole-type dyes, merocyanine dyes, pyrazolone dyes, methine-type dyes, indoaniline-type dyes, azomethine-type dyes such as acetophenoneazomethine, pyrazoloazomethine, imidazoleazomethine, imidazoazomethine, and pyridoneazomethine, xanthene-type dyes, oxazine-type dyes, dicyanostyrene-type dyes such as dicyanostyrene and tricyanostyrene, thiazine-type dyes, azine-type dyes, acridine-type dyes, benzeneazo-type dyes, azo-type dyes such as pyridoneazo, thiopheneazo, isothiazoleazo, pyrroleazo, pyrrazoleazo, imidazoleazo, thiadiazoleazo, triazoleazo, and disazo, spiropyran-type dyes, indolinospiropyran-type dyes, fluoran-type dyes, rhodaminelactam-type dyes, naphthoquinone-type dyes, anthraquinone-type dyes, and quinophthalone-type dyes. Specific examples thereof can include red dyes such as MS Red G (Mitsui Toatsu Kagaku Kabushiki Kaisha), Macrolex Red Violet R (Bayer AG), Ceres Red 7B (Bayer AG), and Samaron Red F3BS (Mitsubishi Chemical Corporation), yellow dyes such as Foron Brilliant Yellow 6GL (Clariant GmbH), PTY-52 (Mitsubishi Chemical Corporation), and Macrolex yellow 6G (Bayer AG), and blue dyes such as Kayaset® Blue 714 (NIPPON KAYAKU Co., Ltd.), Foron Brilliant Blue S-R (Clariant GmbH), MS Blue 100 (Mitsui Toatsu Kagaku Kabushiki Kaisha), and C.I. Solvent 63.

The content of the sublimable dye is preferably 50% by mass or more and 350% by mass or less, more preferably 80% by mass or more and 300% by mass or less, based on the total mass of the binder resin. Setting the content of the sublimable dye to the preferred content described above enables the print density and storage stability to be further improved.

### (Colorant Primer Layer)

When a colorant layer 7 to be used for the sublimation-type thermal transfer method is used as the colorant layer 7, a colorant primer layer (not shown), which is intended for improving the adhesion between the substrate 1 and the colorant layer 7, may be provided between the substrate 1 and the colorant layer 7.

There is no particular limitation on the colorant primer layer, and a colorant primer layer conventionally known in the field of thermal transfer sheets can be appropriately selected and used. An exemplary colorant primer layer is constituted by a resin component. Examples of the resin component constituting the colorant primer layer can include resin components such as polyesters, polyvinyl pyrrolidone, polyvinyl alcohol, polyacrylic esters, polyvinyl acetate, polyurethanes, styrene acrylate, polyacrylamide, polyamides, polyvinyl acetoacetal, and polyvinyl butyral. The colorant primer layer may also contain various additives such as organic particles and inorganic particles along with the resin component.

There is no particular limitation on a method of forming the colorant primer layer, and the colorant primer layer may be formed by dispersing or dissolving the resin component exemplified above and additives to be added as required in an appropriate solvent to prepare a coating liquid for colorant primer layer, applying this coating liquid onto the substrate 1, and drying the applied liquid. There is no particular limitation on the thickness of the colorant primer layer, and the thickness is generally 0.02 μm or more and 1 μm or less.

### (Colorant Layer to be Used for Melt-Type Thermal Transfer Method)

The colorant layer to be used for the melt-type thermal transfer method contains a coloring agent and a binder. Examples of a wax component that can be used as the binder can include various waxes such as microcrystalline wax, carnauba wax, paraffin wax, Fischer-Tropsch wax, various low molecular weight polyethylenes, Japan wax, beeswax, spermaceti, Chinese wax, wool wax, shellac wax, candelilla wax, petrolatum, polyester wax, partially-modified wax, fatty acid esters, and fatty acid amides.

Examples of a resin component that can be used as the binder can include ethylene-vinyl acetate copolymers, ethylene-acrylic acid ester copolymers, polyethylene, polystyrene, polypropylene, polybutene, petroleum resins, vinyl chloride resins, vinyl chloride-vinyl acetate copolymers, polyvinyl alcohol, vinylidene chloride resins, acrylic resins, polyamides, polycarbonate, fluorine resins, polyvinyl formal, polyvinyl butyral, acetyl cellulose, nitrocellulose, polyvinyl acetate, polyisobutylene, ethyl cellulose, and polyvinyl acetoacetal.

The coloring agent may be appropriately selected from known organic or inorganic pigments or dyes, and for example, coloring agents having a sufficient color density and not discoloring and fading due to light, heat, and the like are preferred. The coloring agent may be a material that develops color by heating or a material that develops color when brought into contact with a component applied on the surface of a transfer receiving article. Further, the color of the coloring agent is not limited to cyan, magenta, yellow, and black, and coloring agents of various colors can be used.

### (Transfer Receiving Article)

Examples of the transfer receiving article onto which the transfer layer 10 of the thermal transfer sheet 100 of the present disclosure is to be transferred include thermal transfer image-receiving sheets, plain paper, wood-free paper, tracing paper, plastic films, and plastic cards mainly composed of vinyl chloride, a vinyl chloride-vinyl acetate copolymer, or polycarbonate. As the transfer receiving article, one having a predetermined image also can be used. The transfer receiving article may be colored or may have transparency.

### (Method for Transferring Transfer Layer)

There is no particular limitation on a method for transferring the transfer layer onto a transfer receiving article, and the method can be performed using, for example, a thermal transfer printer having a heating device such as a thermal head, or a heating device such as a hot stamp or a heat roll. The thermal transfer sheet 100 of the present disclosure, which enables prevention of occurrence of print omission on the transfer layer to be transferred, can be suitably used in combination with a thermal transfer printer having a heating device such as a thermal head, which printer is likely to cause print omission in comparison with a hot stamp, a heat roll, or the like.

Although the resin components and the like constituting each layer are herein described exemplarily, each of these resins may be a homopolymer of a monomer constituting each resin, or a copolymer of the main component monomer constituting each resin and one or more other polymers, or a derivative thereof. For example, a reference to an acrylic resin is only required to include a monomer of acrylic acid or methacrylic acid, or an acrylic acid ester or methacrylic acid ester as the main component. The acrylic resin also may be a modified product of these resins. A resin component other than those described herein also may be used.

### EXAMPLES

Next, the present invention will be described more concretely with reference to examples and comparative examples. Hereinbelow, unless otherwise particularly specified, the expression of part(s) or % means that by mass, representing a formulation not in terms of solid content.

### Example 1

As a substrate, a polyethylene terephthalate film having a thickness of 4.5 μm was used. On a portion of one surface of the substrate, a coating liquid for colorant primer layer having the following composition was applied, and the applied liquid was dried to from a colorant primer layer having a thickness of 0.25 μm. A coating liquid for yellow colorant layer, a coating liquid for magenta colorant layer, and a coating liquid for cyan colorant layer having the following composition were applied on this colorant primer layer, and the applied liquids were dried to form a colorant layer, in which a yellow colorant layer, a magenta colorant layer, and a cyan colorant layer each having a thickness of 0.5 μm were provided in this order in a frame-sequential manner. Additionally, on a portion of the one surface of the substrate, a coating liquid for peelable layer having the following composition was applied, and the applied liquid was dried to form a peelable layer having a thickness of 1 μm. Then, a coating liquid for protective layer having the following composition was applied on the peelable layer, the applied liquid was dried to from a protective layer having a thickness of 2 μm. Alternatively, on the other surface of substrate, a coating liquid for back face primer layer 1 having the following composition was applied, and the applied liquid was dried to form a back face primer layer having a thickness of 0.1 μm. A coating liquid for back face layer 1 having the following composition was applied on this back face primer layer, and the applied liquid was dried to form a back face layer having a thickness of 0.4 μm of Example 1. The peelable layer and the protective layer constitute the transfer layer of the thermal transfer sheet of the present disclosure.

### <Coating Liquid for Colorant Primer Layer>

| | |
|---|---|
| Alumina sol | 4 parts |
| (Alumina sol 200, Nissan Chemical, Ltd.) | |
| Cationic polyurethane | 6 parts |
| (SF-600, Dai-ichi Kogyo Seiyaku, Co., Ltd.) | |
| Water | 100 parts |
| Isopropyl alcohol | 100 parts |

### <Coating Liquid for Yellow Colorant Layer>

| | | |
|---|---|---|
| Disperse dye (Foron Brilliant Yellow S-6GL) | 5.5 | parts |
| Polyvinyl acetal | 4.5 | parts |
| (S-LEC(R) KS-5, SEKISUI CHEMICAL CO., LTD.) | | |
| Phosphoric ester type surfactant | 0.1 | part |
| (PLYSURF(R) A208N, Dai-ichi Kogyo Seiyaku, Co., Ltd.) | | |
| Epoxy-modified silicone oil | 0.04 | parts |
| (KF-101, manufactured by Shin-Etsu Chemical Co., Ltd.) | | |
| Polyethylene wax | 0.1 | part |
| Methyl ethyl ketone | 45 | parts |
| Toluene | 45 | parts |

### <Coating Liquid for Magenta Colorant Layer>

| | | |
|---|---|---|
| Disperse dye (MS Red G) | 1.5 | parts |
| Disperse dye (Macrolex Red Violet R) | 2 | parts |
| Polyvinyl acetal | 4.5 | parts |
| (S-LEC(R) KS-5, SEKISUI CHEMICAL CO., LTD.) | | |
| Phosphoric ester type surfactant | 0.1 | part |
| (PLYSURF(R) A208N, Dai-ichi Seiyaku Kogyo, Co., Ltd.) | | |
| Polyethylene wax | 0.1 | part |
| Epoxy-modified silicone oil | 0.04 | parts |
| (KF-101, manufactured by Shin-Etsu Chemical Co., Ltd.) | | |
| Methyl ethyl ketone | 45 | parts |
| Toluene | 45 | parts |

### <Coating Liquid for Cyan Colorant Layer>

| | | |
|---|---|---|
| Disperse dye (Solvent Blue 63) | 3.5 | parts |
| Disperse dye (HSB-2194) | 3 | parts |
| Polyvinyl acetal | 4.5 | parts |
| (S-LEC(R) KS-5, SEKISUI CHEMICAL CO., LTD.) | | |
| Phosphoric ester type surfactant | 0.1 | part |
| (PLYSURF(R) A208N, Dai-ichi Seiyaku Kogyo, Co., Ltd.) | | |
| Polyethylene wax | 0.1 | part |
| Epoxy-modified silicone oil | 0.04 | parts |
| (KF-101, manufactured by Shin-Etsu Chemical Co., Ltd.) | | |
| Methyl ethyl ketone | 45 | parts |
| Toluene | 45 | parts |

### <Coating Liquid for Peelable Layer>

| | |
|---|---|
| Acrylic resin | 29 parts |
| (DIANAL(R) BR-87, Mitsubishi Chemical Corporation) | |
| Polyester | 1 part |
| (Vylon(R) 200, TOYOBO CO., LTD.) | |
| Methyl ethyl ketone | 35 parts |
| Toluene | 35 parts |

<Coating liquid for protective layer>

| | |
|---|---|
| Polyester | 30 parts |
| (Vylon(R) 200, TOYOBO CO., LTD.) | |
| Methyl ethyl ketone | 35 parts |
| Toluene | 35 parts |

### <Coating Liquid for Back Face Primer Layer 1>

| | |
|---|---|
| Polyester (solid content: 30%) | 16.67 parts |
| (POLYESTER(R) WR-961, The Nippon Synthetic | |
| Chemical Industry Co., Ltd.) | |
| Water | 41.67 parts |
| Isopropyl alcohol | 41.67 parts |

### <Coating Liquid for Back Face Layer 1>

| | |
|---|---|
| Alkoxylsilyl group-modified acrylic resin (solid | 340 parts |
| content 50%) | |
| (ACRIT(R) 8SQ-1020, Taisei Fine Chemical Co., Ltd.) | |
| Curing agent (dioctyltin-type catalyst) | 10 parts |
| (Neostan(R) U-830, Nitto Kasei Co., Ltd.) | |
| Silicone oil (solid content 30%) | 33 parts |
| (Cymac(R) U-270, Toagosei Co., Ltd.) | |
| Silicone filler | 10 parts |
| (Tospearl 240(R), Momentive Performance Materials Japan | |
| LLC) | |
| Methyl ethyl ketone | 606 parts |

### Example 2

A thermal transfer sheet of Example 2 was obtained exactly in the same manner as in Example 1 except that the coating liquid for back face layer 1 was replaced by a coating liquid for back face layer 2 having the following composition to form the back face layer.

### <Coating Liquid for Back Face Layer 2>

| | |
|---|---|
| Alkoxylsilyl group-modified acrylic resin | 300 parts |
| (solid content 50%) | |
| (ACRIT(R) 8SQ-1020, Taisei Fine Chemical Co., Ltd.) | |
| Curing agent (dioctyltin-type catalyst) | 10 parts |
| (Neostan(R) U-830, Nitto Kasei Co., Ltd.) | |
| Silicone oil (solid content 30%) | 67 parts |
| (Cymac(R) U-270, Toagosei Co., Ltd.) | |
| Silicone filler | 20 parts |
| (Tospearl 240(R), Momentive Performance Materials Japan | |
| LLC) | |
| Methyl ethyl ketone | 604 parts |

### Example 3

A thermal transfer sheet of Example 3 was obtained exactly in the same manner as in Example 1 except that the coating liquid for back face layer 1 was replaced by a coating liquid for back face layer 3 having the following composition to form the back face layer.

### <Coating Liquid for Back Face Layer 3>

| | |
|---|---|
| Alkoxylsilyl group-modified acrylic resin (solid | 360 parts |
| content 50%) | |
| (ACRIT(R) 8SQ-1020, Taisei Fine Chemical Co., Ltd.) | |
| Curing agent (dioctyltin-type catalyst) | 10 parts |
| (Neostan(R) U-830, Nitto Kasei Co., Ltd.) | |
| Silicone oil (solid content 30%) | 17 parts |
| (Cymac(R) U-270, Toagosei Co., Ltd.) | |
| Silicone filler | 5 parts |
| (Tospearl 240(R), Momentive Performance Materials Japan | |
| LLC) | |
| Methyl ethyl ketone | 608 parts |

### Example 4

A thermal transfer sheet of Example 4 was obtained exactly in the same manner as in Example 1 except that the coating liquid for back face layer 1 was replaced by a coating liquid for back face layer 4 having the following composition to form the back face layer.

### <Coating Liquid for Back Face Layer 4>

| | | |
|---|---|---|
| Alkoxylsilyl group-modified acrylic resin | 372 | parts |
| (solid content 50%) | | |
| (ACRIT(R) 8SQ-1020, Taisei Fine Chemical Co., | | |
| Ltd.) | | |
| Curing agent (dioctyltin-type catalyst) | 10 | parts |
| (Neostan(R) U-830, Nitto Kasei Co., Ltd.) | | |
| Silicone oil (solid content 30%) | 7 | parts |
| (Cymac(R) U-270, Toagosei Co., Ltd.) | | |
| Silicone filler | 2 | parts |
| (Tospearl 240(R), Momentive Performance | | |
| Materials Japan LLC) | | |
| Methyl ethyl ketone | 610 | parts |

### Example 5

A thermal transfer sheet of Example 5 was obtained exactly in the same manner as in Example 1 except that the coating liquid for back face layer 1 was replaced by a coating liquid for back face layer 5 having the following composition to form the back face layer.

### <Coating Liquid for Back Face Layer 5>

| | |
|---|---|
| Alkoxylsilyl group-modified acrylic resin | 340 parts |
| (solid content 50%) | |
| (ACRIT(R) 8SQ-1100, Taisei Fine Chemical Co., Ltd.) | |
| Curing agent (dioctyltin-type catalyst) | 10 parts |
| (Neostan(R) U-830, Nitto Kasei Co., Ltd.) | |
| Zinc stearyl phosphate | 10 parts |
| (LBT-1830 purified, Sakai Chemical Industry | |
| Co., Ltd.) | |
| Talc | 10 parts |
| (MICRO ACE(R) P-3, Nippon Talc Co., Ltd.) | |
| Methyl ethyl ketone | 630 parts |

### Example 6

A thermal transfer sheet of Example 6 was obtained exactly in the same manner as in Example 1 except that the coating liquid for back face layer 1 was replaced by a coating liquid for back face layer 6 having the following composition to form the back face layer.

### <Coating Liquid for Back Face Layer 6>

| | |
|---|---|
| Alkoxylsilyl group-modified acrylic resin | 340 parts |
| (solid content 50%) | |
| (ACRIT(R) 8SQ-1020, Taisei Fine Chemical Co., | |
| Ltd.) | |
| Curing agent (dioctyltin-type catalyst) | 10 parts |
| (Neostan(R) U-830, Nitto Kasei Co., Ltd.) | |
| Zinc stearyl phosphate | 10 parts |
| (LBT-1830 purified, Sakai Chemical Industry | |
| Co., Ltd.) | |
| Talc | 10 parts |
| (MICRO ACE(R) P-3, Nippon Talc Co., Ltd.) | |
| Methyl ethyl ketone | 630 parts |

### Example 7

A thermal transfer sheet of Example 7 was obtained exactly in the same manner as in Example 1 except that the coating liquid for back face layer 1 was replaced by a coating liquid for back face layer 7 having the following composition to form the back face layer.

### <Coating Liquid for Back Face Layer 7>

| | |
|---|---|
| Alkoxylsilyl group-modified acrylic resin | 340 parts |
| (solid content 50%) | |
| (ACRIT(R) 8SQ-1020, Taisei Fine Chemical Co., | |
| Ltd.) | |
| Curing agent (dioctyltin-type catalyst) | 10 parts |
| (Neostan(R) U-830, Nitto Kasei Co., Ltd.) | |
| Zinc stearyl phosphate | 10 parts |
| (LBT-1830 purified, Sakai Chemical Industry | |
| Co., Ltd.) | |
| Silicone filler | 10 parts |
| (Tospearl 240(R), Momentive Performance | |
| Materials Japan LLC) | |
| Methyl ethyl ketone | 630 parts |

### Example 8

A thermal transfer sheet of Example 8 was obtained exactly in the same manner as in Example 1 except that the coating liquid for back face layer 1 was replaced by a coating liquid for back face layer 8 having the following composition to form the back face layer.

### <Coating Liquid for Back Face Layer 8>

| | |
|---|---|
| Alkoxylsilyl group-modified acrylic resin | 340 parts |
| (solid content 50%) | |
| (ACRIT(R) 8SQ-1020, Taisei Fine Chemical | |
| Co., Ltd.) | |
| Curing agent (dioctyltin-type catalyst) | 10 parts |
| (Neostan(R) U-830, Nitto Kasei Co., Ltd.) | |
| Silicone oil (solid content 30%) | 33 parts |
| (Cymac(R) U-270, Toagosei Co., Ltd.) | |
| Talc | 10 parts |
| (MICRO ACE(R) P-3, Nippon Talc Co., Ltd.) | |
| Methyl ethyl ketone | 606 parts |

### Example 9

A thermal transfer sheet of Example 9 was obtained exactly in the same manner as in Example 1 except that the coating liquid for back face layer 1 was replaced by a coating liquid for back face layer 9 having the following composition to form the back face layer.

### <Coating Liquid for Back Face Layer 9>

| | |
|---|---|
| Alkoxylsilyl group-modified acrylic resin (solid | 280 parts |
| content 50%) | |
| (ACRIT(R) 8SQ-1020, Taisei Fine Chemical Co., | |
| Ltd.) | |
| Curing agent (dioctyltin-type catalyst) | 10 parts |
| (Neostan(R) U-830, Nitto Kasei Co., Ltd.) | |
| Zinc stearyl phosphate | 40 parts |
| (LBT1830 purified, Sakai Chemical Industry Co., | |
| Ltd.) | |
| Talc | 10 parts |
| (MICRO ACE(R) P-3, Nippon Talc Co., Ltd.) | |
| Methyl ethyl ketone | 660 parts |

### Example 10

A thermal transfer sheet of Example 10 was obtained exactly in the same manner as in Example 1 except that the coating liquid for back face layer 1 was replaced by a coating liquid for back face layer 10 having the following composition to form the back face layer.

### <Coating Liquid for Back Face Layer 10>

| | |
|---|---|
| Alkoxylsilyl group-modified acrylic resin (solid | 280 parts |
| content 50%) | |
| (ACRIT(R) 8SQ-1020, Taisei Fine Chemical Co., | |
| Ltd.) | |
| Curing agent (dioctyltin-type catalyst) | 10 parts |
| (Neostan(R) U-830, Nitto Kasei Co., Ltd.) | |
| Zinc stearyl phosphate | 40 parts |
| (LBT1830 purified, Sakai Chemical Industry Co., | |
| Ltd.) | |
| Silicone filler | 10 parts |
| (Tospearl 240(R), Momentive Performance | |
| Materials Japan LLC) | |
| Methyl ethyl ketone | 660 parts |

### Example 11

A thermal transfer sheet of Example 11 was obtained exactly in the same manner as in Example 1 except that the coating liquid for back face layer 1 was replaced by a coating liquid for back face layer 11 having the following composition to form the back face layer.

### <Coating Liquid for Back Face Layer 11>

| | |
|---|---|
| Alkoxylsilyl group-modified acrylic resin | 200 parts |
| (solid content 50%) | |
| (ACRIT(R) 8SQ-1020, Taisei Fine Chemical Co., | |
| Ltd.) | |
| Curing agent (dioctyltin-type catalyst) | 10 parts |
| (Neostan(R) U-830, Nitto Kasei Co., Ltd.) | |
| Zinc stearyl phosphate | 80 parts |
| (LBT1830 purified, Sakai Chemical Industry | |
| Co., Ltd.) | |
| Talc | 10 parts |
| (MICRO ACE(R) P-3, Nippon Talc Co., Ltd.) | |
| Methyl ethyl ketone | 700 parts |

### Example 12

A thermal transfer sheet of Example 12 was obtained exactly in the same manner as in Example 1 except that the coating liquid for back face layer 1 was replaced by a coating liquid for back face layer 12 having the following composition to form the back face layer.

### <Coating Liquid for Back Face Layer 12>

| | |
|---|---|
| Alkoxylsilyl group-modified acrylic resin | 280 parts |
| (solid content 50%) | |
| (ACRIT(R) 8SQ-1020, Taisei Fine Chemical | |
| Co., Ltd.) | |
| Curing agent (dioctyltin-type catalyst) | 10 parts |
| (Neostan(R) U-830, Nitto Kasei Co., Ltd.) | |
| Zinc stearate | 40 parts |
| (SZ-PF, Sakai Chemical Industry Co., Ltd.) | |
| Talc | 10 parts |
| (MICRO ACE(R) P-3, Nippon Talc Co., Ltd.) | |
| Methyl ethyl ketone | 660 parts |

### Example 13

A thermal transfer sheet of Example 13 was obtained exactly in the same manner as in Example 1 except that the coating liquid for back face layer 1 was replaced by a coating liquid for back face layer 13 having the following composition to form the back face layer.

### <Coating Liquid for Back Face Layer 13>

| | |
|---|---|
| Alkoxylsilyl group-modified acrylic resin | 280 parts |
| (solid content 50%) | |
| (ACRIT(R) 8SQ-1020, Taisei Fine Chemical | |
| Co., Ltd.) | |
| Curing agent (dioctyltin-type catalyst) | 10 parts |
| (Neostan(R) U-830, Nitto Kasei Co., Ltd.) | |
| Zinc stearate | 40 parts |
| (SZ-PF, Sakai Chemical Industry Co., Ltd.) | |
| Silicone filler | 10 parts |
| (Tospearl 240(R), Momentive Performance | |
| Materials Japan LLC) | |
| Methyl ethyl ketone | 660 parts |

### Example 14

A thermal transfer sheet of Example 14 was obtained exactly in the same manner as in Example 1 except that the coating liquid for back face primer layer 1 was replaced by a coating liquid for back face primer layer 2 having the following composition to form the back face primer layer and the coating liquid for back face layer 1 was replaced by the coating liquid for back face layer 7 having the above composition to form the back face layer.

### <Coating Liquid for Back Face Primer Layer 2>

| | |
|---|---|
| Alkoxylsilyl group-containing acrylic resin | 20 parts |
| (solid content 50%) | |
| (8SQ-1020, Taisei Fine Chemical Co., Ltd.) | |
| Dioctyltin-type catalyst | 0.5 parts |
| (U-830, Nitto Kasei Co., Ltd.) | |
| Methyl ethyl ketone | 80 parts |

### Comparative Example 1

A thermal transfer sheet of Comparative Example 1 was obtained exactly in the same manner as in Example 1 except that the coating liquid for back face layer 1 was replaced by a coating liquid for back face layer A having the following composition to form the back face layer.

### <Coating Liquid for Back Face Layer A>

| | |
|---|---|
| Polyvinyl acetal | 98 parts |
| (S-LEC(R) KS-1, SEKISUI CHEMICAL CO., LTD.) | |
| Curing agent (polyisocyanate) (solid content | 83 parts |
| 75%) | |
| (BURNOCK(R) D750, DIC Corporation) | |
| Zinc stearyl phosphate | 20 parts |
| (LBT-1830 purified, Sakai Chemical Industry Co., | |
| Ltd.) | |
| Talc | 20 parts |
| (MICRO ACE(R) P-3, Nippon Talc Co., Ltd.) | |
| Methyl ethyl ketone | 390 parts |
| Toluene | 390 parts |

### Comparative Example 2

A thermal transfer sheet of Comparative Example 2 was obtained exactly in the same manner as in Example 1 except that the coating liquid for back face layer 1 was replaced by a coating liquid for back face layer B having the following composition to form the back face layer.

### <Coating Liquid for Back Face Layer B>

| | |
|---|---|
| Polyvinyl acetal | 98 parts |
| (S-LEC(R) KS-1, SEKISUI CHEMICAL CO., LTD.) | |
| Curing agent (polyisocyanate) (solid content | 83 parts |
| 75%) | |
| (BURNOCK(R) D750, DIC Corporation) | |
| Silicone oil (solid content 30%) | 67 parts |
| (Cymac(R) U-270, Toagosei Co., Ltd.) | |
| Talc | 20 parts |
| (MICRO ACE(R) P-3, Nippon Talc Co., Ltd.) | |
| Methyl ethyl ketone | 366 parts |
| Toluene | 366 parts |

### Comparative Example 3

A thermal transfer sheet of Comparative Example 3 was obtained exactly in the same manner as in Example 1 except that the coating liquid for back face layer 1 was replaced by a coating liquid for back face layer C having the following composition to form the back face layer.

### <Coating Liquid for Back Face Layer C>

| | |
|---|---|
| Polyvinyl acetal | 98 parts |
| (S-LEC(R) KS-1, SEKISUI CHEMICAL CO., LTD.) | |
| Curing agent (polyisocyanate) (solid content | 83 parts |
| 75%) | |
| (BURNOCK(R) D750, DIC Corporation) | |
| Silicone oil (solid content 30%) | 67 parts |
| (Cymac(R) U-270, Toagosei Co., Ltd.) | |
| Silicone filler | 20 parts |
| (Tospearl 240(R), Momentive Performance Materials Japan | |
| LLC) | |
| Methyl ethyl ketone | 366 parts |
| Toluene | 366 parts |

### Comparative Example 4

A thermal transfer sheet of Comparative Example 4 was obtained exactly in the same manner as in Example 1 except that the coating liquid for back face layer 1 was replaced by a coating liquid for back face layer D having the following composition to form the back face layer.

### <Coating Liquid for Back Face Layer D>

| | | |
|---|---|---|
| Polyvinyl acetal | 74 | parts |
| (S-LEC(R) KS-1, SEKISUI CHEMICAL CO., LTD.) | | |
| Curing agent (polyisocyanate) (solid content | 61 | parts |
| 75%) | | |
| (BURNOCK(R) D750, DIC Corporation) | | |
| Silicone oil (solid content 30%) | 133 | parts |
| (Cymac(R) U-270, Toagosei Co., Ltd.) | | |
| Silicone filler | 40 | parts |
| (Tospearl 240(R), Momentive Performance | | |
| Materials Japan LLC) | | |
| Methyl ethyl ketone | 346 | parts |
| Toluene | 346 | parts |

### (Calculation of Si Weight Ratio)

When the element weight ratio of the surface of the back face layer of the thermal transfer sheet of each of Examples and Comparative Examples was measured using a combination of a scanning electron microscope (SU1510, Hitachi High-Technologies Corporation) and an energy dispersive X-ray spectrometer (EDAX OCTANE PRIME, AMETEK, Inc.) under the following element weight ratio measurement conditions A, the weight ratio of Si (%) with respect to the weight ratio of C was calculated. In advance of the measurement, the back face layer was subjected to sputtering (target: Pt (platinum)) to form a Pt (platinum) thin film having a thickness of 10 nm or less. The weight ratio of Si (%) is shown in Table 1 (in the “Si weight ratio (%)” column in Table 1).

(Element Weight Ratio Measurement Conditions A)
Acceleration voltage: 5 kV
Measurement time: 3 minutes
Measurement magnification: 1000 times

(Calculation of Zn Weight Ratio)

When the element weight ratio of the surface of the back face layer of the thermal transfer sheet of each of Examples and Comparative Examples, the back face layer including Pt (thin film) formed thereon, was measured using a combination of a scanning electron microscope (SU1510, Hitachi High-Technologies Corporation) and an energy dispersive X-ray spectrometer (EDAX OCTANE PRIME, AMETEK, Inc.) under the following element weight ratio measurement conditions B, the weight ratio of Zn (%) with respect to the weight ratio of C was calculated. The weight ratio of Zn (%) is shown in Table 1 (in the “Zn weight ratio (%)” column in Table 1).

(Element Weight Ratio Measurement Conditions B)
Acceleration voltage: 10 kV
Measurement time: 3 minutes
Measurement magnification: 100 times

### (Calculation of Mass Reduction Ratio of Thermal Transfer Sheet)

The thermal transfer sheet of each of Examples and Comparative Examples was subjected to a rubbing test on the basis of the above condition 2, and the mass reduction ratio (%) of the thermal transfer sheet between before and after the rubbing test was calculated in accordance with the above equation (1). The calculation results are also shown in Table 1 (in the column “Mass reduction ratio (%)” in Table 1).

### (Production of Print)

By use of a sublimable-type thermal transfer printer (DS40, Dai Nippon Printing Co., Ltd.) and the thermal transfer sheet of each of Examples and Comparative Examples prepared above, a black solid image was printed on a genuine image receiving sheet of the sublimable-type thermal transfer printer as a transfer receiving article under the default conditions of the printer to obtain an image-formed product. Then, by use of the above sublimable-type thermal transfer printer, the transfer layer of the thermal transfer sheet of each of Examples and Comparative Examples was transferred onto the image-formed product obtained above under the default conditions of the printer to obtain a print of each of Examples and Comparative Examples, in which the image-formed product was formed on the transfer receiving article and the transfer layer was formed on this image-formed product. Ten prints of each of Examples and Comparative Examples were continuously produced.

(Gloss evaluation)

The glossiness of the surface of the print of each of Examples and Comparative Examples obtained in the formation of the print described above was measured using a glossiness meter (Glossmeter VG7000 (Nippon Denshoku Industries Co. Ltd.) (measurement angle: 20°), and gloss evaluation was conducted under the following evaluation criteria. The evaluation results are shown in Table 1 (the column “Gloss” in Table 1). The glossiness is measured on all the 10 prints of each of Examples and Comparative Examples, and the average of the measurements is taken as the glossiness of each of Examples and Comparative Examples. The glossiness in the main scanning direction is the glossiness obtained by measurement along the TD direction of the print, and the glossiness in the sub-scanning direction is the glossiness obtained by measurement along the MD direction of the print. The MD direction is the flow direction of prints (printer ejection direction), and the TD direction is the direction perpendicular to the MD direction.

“Evaluation criteria”

A: The glossiness in the main scanning direction is 59 or more, and the glossiness in the sub-scanning direction is 50 or more.

B: The glossiness in the main scanning direction is 57 or more and less than 59, and the glossiness in the sub-scanning direction is 48 or more, or the glossiness in the main scanning direction is 57 or more, and the glossiness in the sub-scanning direction is 48 or more and less than 50.

NG: The glossiness in the main scanning direction is less than 57, or the glossiness in the sub-scanning direction is less than 48.

### (Evaluation of Print Omission)

Print omission on the prints produced was evaluated under the following evaluation criteria. The evaluation results are shown in Table 1 (the column “print omission” in Table 1).

### “Evaluation Criteria”

A: No print omission on the transfer layer and image-formed product occurs in any of the prints.

B: Print omission on the transfer layer or image-formed product occurs in one of the prints.

NG: Print omission on the transfer layer occurs in two or more of the prints.

TABLE 1

| | Details of back face layer | | | | | | | |
|---|---|---|---|---|---|---|---|---|
| | | | | Si | Zn | Mass | | |
| | | | | weight ratio | weight ratio | reduction ratio | Print | |
| | Binder type | Lubricant type | Filler type | (%) | (%) | (%) | omission | Gloss |
| Example 1 | Si-containing acryl | Si-type | Si-type | 55 | — | 0 | A | A |
| Example 2 | Si-containing acryl | Si-type | Si-type | 81 | — | 0.2 | A | A |
| Example 3 | Si-containing acryl | Si-type | Si-type | 50 | — | 0.4 | A | A |
| Example 4 | Si-containing acryl | Si-type | Si-type | 44 | — | 0.2 | B | A |
| Example 5 | Si-containing acryl | Non Si-type | Non Si-type | 19 | 5.0 | 0.2 | B | B |
| Example 6 | Si-containing acryl | Non Si-type | Non Si-type | 45 | 5.0 | 0 | B | B |
| Example 7 | Si-containing acryl | Non Si-type | Si-type | 52 | 5.2 | 0.1 | B | A |
| Example 8 | Si-containing acryl | Si-type | Non Si-type | 50 | — | 0.4 | A | B |
| Example 9 | Si-containing acryl | Non Si-type | Non Si-type | 35 | 8.0 | 0.2 | A | B |
| Example 10 | Si-containing acryl | Non Si-type | Si-type | 39 | 7.7 | 0.2 | A | B |
| Example 11 | Si-containing acryl | Non Si-type | Non Si-type | 29 | 11.9 | 0.4 | A | B |
| Example 12 | Si-containing acryl | Non Si-type | Non Si-type | 35 | 7.6 | 0.2 | A | B |
| Example 13 | Si-containing acryl | Non Si-type | Si-type | 41 | 7.9 | 0.2 | A | B |
| Example 14 | Si-containing acryl | Non Si-type | Si-type | 52 | 5.2 | 0.1 | A | A |
| Comparative | Polyvinyl acetal | Non Si-type | Non Si-type | 11 | 5.8 | 2.8 | NG | NG |
| Example 1 | | | | | | | | |
| Comparative | Polyvinyl acetal | Si-type | Non Si-type | 16 | — | 2.7 | NG | NG |
| Example 2 | | | | | | | | |
| Comparative | Polyvinyl acetal | Si-type | Si-type | 27 | — | 2.9 | A | NG |
| Example 3 | | | | | | | | |
| Comparative | Polyvinyl acetal | Si-type | Si-type | 72 | — | 3.2 | A | NG |
| Example 4 | | | | | | | | |

### REFERENCE SIGNS LIST

1 Substrate
5 Protective layer
6 Adhesive layer
7 Colorant layer
10 Transfer layer
20 Back face layer
25 Back face primer layer
100 Thermal transfer sheet

1. A thermal transfer sheet comprising a back face layer provided on one surface of a substrate and a transfer layer provided on the other surface of the substrate, wherein
the transfer layer has a single-layer structure or a layered structure comprising a protective layer,
the back face layer contains a resin component including Si in a structure, and
when the thermal transfer sheet is cut out to a size of 30 mm×230 mm, both ends in 5 mm of the 230 mm width of the cut-out thermal transfer sheet are fixed on a fixing table, and a rubbing test is conducted, in which test, a white cotton cloth for friction impregnated with methyl ethyl ketone, with a load of 1.96 N applied thereon, is reciprocated 100 times at a rate of 30 reciprocations per minute on a 30 mm×220 mm area of the back face layer of the fixed thermal transfer sheet in a 220 mm width direction, a mass reduction ratio represented by the following equation is 1% or less.
Mass reduction ratio (%)=((mass of thermal transfer sheet before rubbing test−mass of thermal transfer sheet after rubbing test)/mass of thermal transfer sheet before rubbing test))×100 Equation (1)

2. The thermal transfer sheet according to claim 1, wherein,
when an element weight ratio of the back face layer surface is measured using an energy dispersive fluorescent X-ray analyzer under the following element weight ratio measurement conditions A, a weight ratio of Si with respect to a weight ratio of C is 15% or more.
(Element weight ratio measurement conditions A)
Acceleration voltage: 5 kV
Measurement time: 3 minutes
Measurement magnification: 1000 times

3. The thermal transfer sheet according to claim 1, wherein
the back face layer contains a metal soap containing Zn and
when the element weight ratio of the back face layer surface is measured using an energy dispersive fluorescent X-ray analyzer under the following element weight ratio measurement conditions B, a weight ratio of Zn with respect to the weight ratio of C is 4% or more.
(Element weight ratio measurement conditions B)
Acceleration voltage: 10 kV
Measurement time: 3 minutes
Measurement magnification: 100 times

4. A thermal transfer sheet comprising a back face layer provided on one surface of a substrate and a transfer layer provided on the other surface of the substrate, wherein
the back face layer contains a resin having an alkoxylsilyl group.

5. The thermal transfer sheet according to claim 4, wherein
one or two or more layers are provided between the substrate and the back face layer, and
the one layer or the two or more layers contain a resin having an alkoxylsilyl group.

6. The thermal transfer sheet according to claim 4, wherein
a primer layer is provided between the substrate and the back face layer, and
the primer layer contains a resin having an alkoxylsilyl group.

7. The thermal transfer sheet according to claim 4, wherein the resin having an alkoxylsilyl group is an alkoxylsilyl group-modified acrylic resin.

8. The thermal transfer sheet according to claim 4, wherein the back face layer contains a metal soap containing Zn.

9. The thermal transfer sheet according to claim 8, wherein the metal soap containing Zn is zinc stearate or zinc stearyl phosphate.

10. The thermal transfer sheet according to claim 1, wherein the back face layer contains a silicone oil.

11. The thermal transfer sheet according to claim 1, wherein the back face layer contains a silicone filler.
